(19) United States
(12) Patent Application Publication
(10) Pub. No.: US 2011/0004431 A1
(43) Pub. Date: Jan. 6, 2011

(54) DEVICE AND METHOD FOR COMPUTER-ASSISTED 2D NAVIGATION IN A MEDICAL PROCEDURE

(76) Inventors: Martin Ringholz, Erlangen (DE); Stefan Schneider, Erlangen (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/828,649

(22) Filed: Jul. 1, 2010

(30) Foreign Application Priority Data
Jul. 1, 2009 (DE) 10 2009 031 400.8

(51) Int. Cl. G06F 19/00

(52) U.S. Cl. 702/94

(57) ABSTRACT

In a device and method for computer-assisted 2D navigation in a medical procedure, parameters of projection matrices of a 3D calibration process of a C-arm unit are used for the 2D navigation.

### BACKGROUND OF THE INVENTION

1. Field of the Invention

The subject matter of the invention is a device and a method for computer-assisted 2D navigation implemented during a medical procedure.

2. Description of the Prior Art

A number of steps, in particular coordinate transformations between various coordinate systems respectively associated with different objects, are needed for image registration in a medical procedure. In navigation during such a procedure, in particular in a computer-assisted navigation, the positions of trackable objects (for example instruments, patient clamps, marker rings) are detected at the x-ray image intensifier of a Fluoroscopy system. A characteristic arrangement of at least three optical markers is located on each trackable object. These three optical markers can be arranged, for example, in a star configuration. In previous known 2D navigation methods, the bearing of the x-ray image relative to the beam geometry is detected via x-ray markers.

Such a computer-intensive registration method is necessary in order to determine the position of the respective objects and their respective positions relative to one another.

Previous methods for image registration entail the disadvantage that important image information may possibly be covered by the metal spheres of the x-ray markers that are imaged in the x-ray image.

### SUMMARY OF THE INVENTION

An object of the present invention is to provide a device and a method associated with this for such registration, that avoid the aforementioned disadvantage.

In the device and the method, a positioning device to detect the alignment of the imaging unit is provided for the use of projection matrices, wherein 3D calibration data of the imaging unit are stored in a memory unit and are retrieved for the 2D navigation corresponding to the current alignment of the imaging unit.

The subject matter of the invention has the advantage that the use of x-ray marker spheres arranged in at least two planes is not needed since respective projection matrices with extrinsic and intrinsic parameters can be determined from the 3D calibration data.

The invention has the advantage of an improved clinical workflow since the total distance between the x-ray source and detector of a C-arm can be used without limitation.

The invention also has the advantage that no information in the x-ray images is occluded by imaged x-ray markers.

The invention also has the advantage that an image distortion during the registration process can be foregone due to the projection matrices that are already present.

### BRIEF DESCRIPTION OF THE DRAWINGS

FIG. 1 schematically illustrates a conventional registration method.

FIG. 2 schematically illustrates an embodiment of a device according to the invention.

FIG. 3 schematically illustrates another embodiment of a device according to the invention.

FIG. 4 schematically illustrates a technique in accordance with the invention.

### DESCRIPTION OF THE PREFERRED EMBODIMENTS

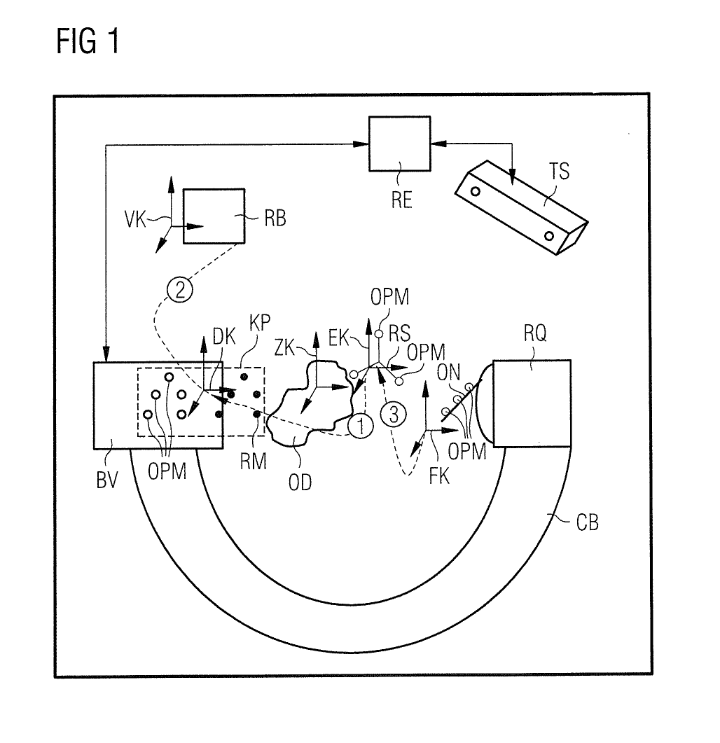

For a better understanding of the subject matter of the invention, a known type of registration is described. A tracking camera TS, a computer RE to link the collected image or x-ray image data, an x-ray unit CB (composed of x-ray source RQ and a detector or an image intensifier unit BV) are shown for the realization of the registration method. For example, the two-dimensional x-ray images that can be acquired at the detector BV of the x-ray unit CB can be merged into a volume image in the computer RE. For example, the optical information acquired by the cameras of the tracking unit TS—the optical information of the optical markers, for example—are evaluated in the same computer RE. Optical markers are arranged at a stationary hardware interface KP on the housing of the image intensifier BV of the C-arm CB, at a reference star RS which is mounted on an object OD and on a surgical instrument ON. For example, the optical markers are attached to a star with three arms. This star has a characteristic shape that is detected by the tracking camera TS. Furthermore, first, second, third, fourth and fifth coordinate systems EK, ZK, DK, VK and FK are shown the respective objects from FIG. 1. The first coordinate system EK can, for example, be associated with an orientation device RS with optical markers OPM. The second coordinate system is associated with a subject OD of which x-ray images RB are generated by means of the C-arm unit. Optical markers as well as x-ray markers are associated with the third coordinate system DK arranged, for example, within a stationary hardware interface KP mounted on the image intensifier unit BV of the C-arm unit CB. A fourth coordinate system VK is associated with the x-ray images RB of a patient that are acquired. In this x-ray image RB the x-ray marker spheres associated with the image intensifier BV are imaged. The fifth coordinate system FK is, for example, associated with a surgical instrument ON. Optical marker spheres OPM are likewise mounted in a characteristic arrangement on this surgical instrument ON.

In the shown configuration, a registration process proceeds in multiple stages, for example 1-3. First a relationship is established between a reference star associated with an eddy clamp RS (with which the first coordinate system EK is associated) and the optical marker spheres OPM that are arranged on the image intensifier unit BV. A connection is subsequently established between the x-ray markers at the image intensifier BV and the fourth coordinate system VK associated with the x-ray exposure. The third coordinate system DK is associated with the optical markers OPM and the x-ray markers RM at the image intensifier BV. The position of the x-ray markers describes the beam geometry of the x-ray unit CB. The computer RE calculates a relationship between the first coordinate system EK and the fourth coordinate system VK. While the surgeon conducts operative procedures on the patient by means of a surgical instrument ON, the characteristic arrangement of the optical markers OPM at the surgical instrument ON is detected via the optical tracking system TS. Through the previously determined relationship between the reference star RS and the x-ray image, a relationship between the surgical instrument ON [sic] can thus be shown continuously and currently at the x-ray image RB (for example on a monitor) via the reference star RS.

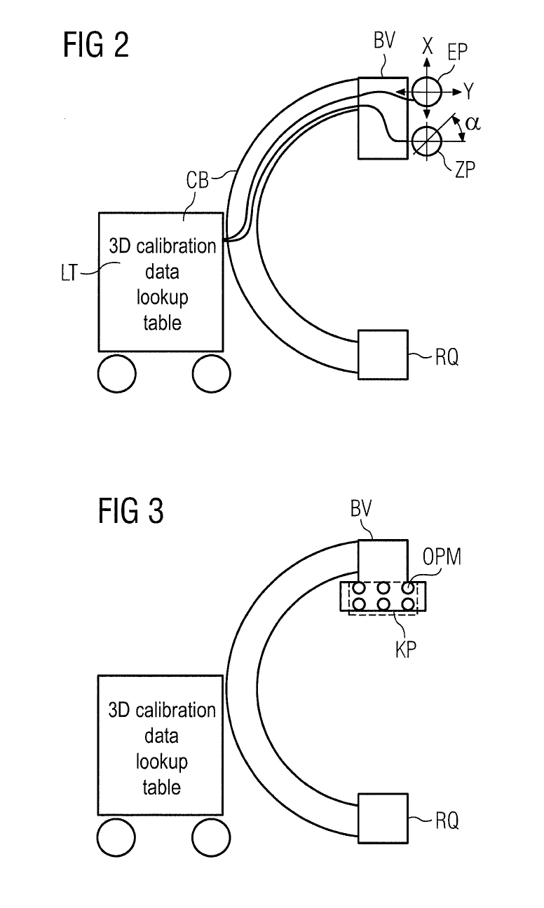

According to the invention, FIG. 2 schematically depicts the x-ray unit CB with the x-ray source RQ as well as the image intensifier unit BV. The positioning device is likewise schematically shown with first and second position transmitters EP, ZP. The first position transmitter EP delivers the current orbital angle; on the other hand, the second position transmitter ZP delivers the angulation angle of the C-arm. In a unit associated with the C-arm CB, the position-specific 3D calibration data saved during a calibration process are, for example, stored in lookup tables LT in a memory unit associated with the computer RE.

A projection matrix describes the transformation from the second coordinate system ZK to the fourth coordinate system VK for a specific angle. In order to obtain a relationship between the third coordinate system and fourth coordinate system DK, VK, the marker geometry must be linked with the image intensifier geometry. For this the parameters of the projection matrix can be divided into two groups, the intrinsic and extrinsic parameters. The intrinsic parameters describe the imaging system itself, thus the pixel size of the detector, and the intersection of the optical axis on the detector, starting from the tube focus. The extrinsic parameters are the position and orientation of the imaging system relative to a stationary coordinate system. The stationary coordinate system can be the marker geometry that is linked with the third coordinate system DK. During the 3D calibration of the C-arm unit CB, both apparatus-specific data given angular or swivel motion and from the corresponding combination possibilities with an angular/orbital/swivel position of discrete steps are stored in the computer RE. In the following operation the apparatus-specific data that were detected and stored during the calibration process are then accessed. A 3D acquisition typically includes multiple projection images that are applied along a rotation, thus for example a 190° orbital rotation or a 360° angular rotation. The positions in which x-ray images are applied must be reproducible both for the 3D calibration and for a 3D scan.

As indicated in FIG. 2, the C-arm unit CB has first and second position transmitters EP, ZP. The orientation of the C-arm in space can be determined by means of these schematically shown position transmitters. The associated lookup tables LT regarding the respective 2D x-ray image exposures can be accessed based on the orientation data derived from these position transmitters. The current position can be obtained via the angle position transmitters EP and ZP at the apparatus itself, as described above. Due to the determined position of the C-arm unit CP, corresponding 3D projection matrices in the lookup table with the associated extrinsic or, respectively, intrinsic parameter data. If there is no agreement between the 2D image data acquired at a specific orbital and angulation angle during calibration phase and the momentary position of the C-arm unit CB, via the stored projection matrices the momentary position of the C-arm unit CB at the nearest projection matrices are used for further calculation. By interpolation of adjacent projection matrices, the projection matrix that is appropriate for the momentary position of the C-arm unit CB can be determined.

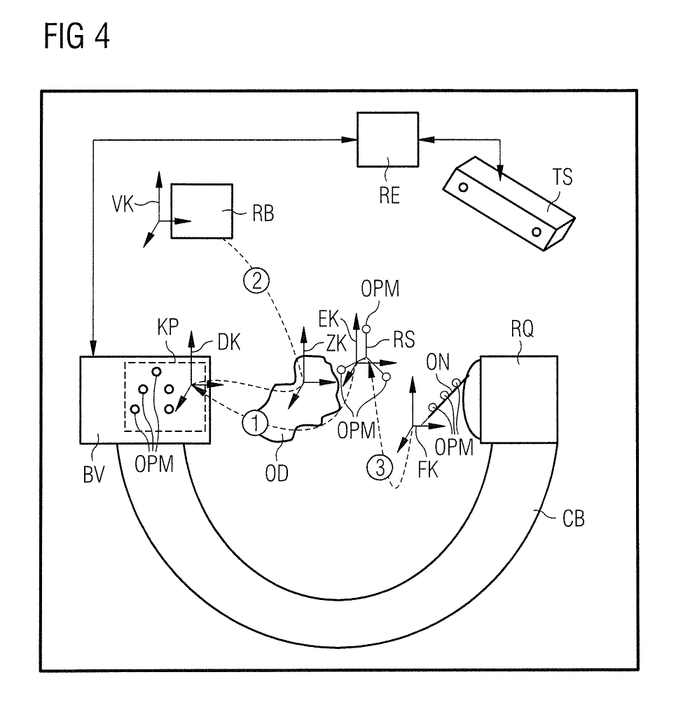

The arrangement shown in FIG. 4 has no x-ray marker at the stationary hardware interface KP. An optical tracking system TS, the computer RE and the C-arm CB with the x-ray source RQ and the image intensifier unit BV are shown in FIG. 4. Optical markers OPM are arranged at the image intensifier unit BV, at an orientation device RS arranged on the subject OD and on an optical instrument ON. A first coordinate system EK is associated with the orientation unit RS; a second coordinate system ZK is associated with the subject OD; a third coordinate system DK is associated with the image intensifier unit BV of the C-arm CB; a fourth coordinate system VK is associated with the x-ray image RB of the patient; and a fifth coordinate system FK is associated with the surgical instrument ON.

In this device and the associated method for 2D navigation with an imaging unit CB, BV, RQ, an optical tracking system TS and a computer RE, the alignment of the imaging unit CB, BV, RQ is detected with the positioning device EP, ZP, KP and parameters of projection matrices corresponding to the current alignment of the imaging unit; 3D calibration data of the imaging unit CB, BV, RQ, RE are accessed by means of the computer RE in order to derive from these a relationship between trackable objects for a 2D navigation.

The registration ensues in the manner that a link between the first coordinate system EK and the optical markers OPM (with which the third coordinate system DK is associated) arranged on the image intensifier BV is established by the optical tracking system TS via the orientation device RS. A transformation between the third coordinate system and the second coordinate system ZK is subsequently [sic] and is established via the calibration data regarding the x-ray image (with which the fourth coordinate system VK is associated) that are already stored in the lookup tables. The continuously changing relationship between the fifth coordinate system and first coordinate system is likewise established during the navigation-assisted surgical procedure.

Although modifications and changes may be suggested by those skilled in the art, it is the intention of the inventor to embody within the patent warranted hereon all changes and modifications as reasonably and properly come within the scope of his contribution to the art.

We claim as our invention:

1. A device for two-dimensional navigation of a medical instrument during a medical procedure, comprising:
an imaging unit that obtains an image of a subject undergoing a medical procedure;
a positioning device that optically detects an alignment of the imaging unit by generating three-dimensional calibration data representing a current alignment of the imaging unit; and
a computerized processor configured to analyze projection matrices represented by said 3D calibration data to access parameters of said projection matrices corresponding to said current alignment and, from said parameters, automatically derive a spatial relationship between objects used in said medical procedure for two-dimensional navigation of at least one of said objects.

2. A device as claimed in claim 1 wherein said positioning device comprises a first optical position transmitter and a second optical position transmitter.

3. A device as claimed in claim 1 wherein said positioning device comprises a stationary hardware interface comprising at least one ring containing optical markers.

4. A method for two-dimensional navigation of a medical instrument during a medical procedure, comprising the steps of:
using an imaging unit, obtaining an image of a subject undergoing a medical procedure;
with a positioning device, optically detect an alignment of the imaging unit by generating three-dimensional calibration data representing a current alignment of the imaging unit; and
in a computerized processor, analyzing projection matrices represented by said 3D calibration data to access parameters of said projection matrices corresponding to said current alignment and, from said parameters, automatically deriving a spatial relationship between objects used in said medical procedure for two-dimensional navigation of at least one of said objects.
